(19) United States
(12) Patent Application Publication
(10) Pub. No.: US 2025/0267554 A1
(43) Pub. Date: Aug. 21, 2025

(54) CONFIGURING AND ACTIVATING ON DEMAND SSB IN SCELL

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US); Hongbo Si, Allen, TX (US)

(21) Appl. No.: 19/186,491

(22) Filed: Apr. 22, 2025

Related U.S. Application Data
(60) Provisional application No. 63/643,660, filed on May 7, 2024.
(60) Provisional application No. 63/655,256, filed on Jun. 3, 2024.

(51) Int. Cl. H04W 48/08; H04W 72/1273

(52) U.S. Cl. CPC H04W 48/08; H04W 72/1273

(57) ABSTRACT

A user equipment (UE) includes a transceiver. The transceiver is configured to receive, from a base station (BS), a message including a configuration for on-demand synchronization signal block (SSB) transmission for one or more secondary cells (SCells), and receive, from the BS, a medium access control (MAC) control element (CE) indicating whether on-demand SSB transmission is activated for the one or more SCells. The UE also includes a processor operably coupled to the transceiver. The processor is configured to determine, based on the MAC CE, whether on-demand SSB transmission is activated for an SCell configured with on-demand SSB transmission, and in response to a determination that on-demand SSB transmission is activated for the SCell, measure the on-demand SSB transmission for the SCell.

### CROSS-REFERENCE TO RELATED APPLICATIONS AND CLAIM OF PRIORITY

This application claims priority under 35 U.S.C. § 119 (e) to U.S. Provisional Patent Application No. 63/643,660 filed on May 7, 2024, and U.S. Provisional Patent Application No. 63/655,256 filed on Jun. 3, 2024. The above-identified provisional patent applications are hereby incorporated by reference in their entirety.

### TECHNICAL FIELD

This disclosure relates generally to wireless networks. More specifically, this disclosure relates to configuring and activating on demand SSB transmission in secondary cells (SCells).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for configuring and activating on demand SSB transmission in SCells.

In one embodiment, a user equipment (UE) is provided. The UE includes a transceiver. The transceiver is configured to receive, from a base station (BS), a message including a configuration for on-demand synchronization signal block (SSB) transmission for one or more secondary cells (SCells), and receive, from the BS, a medium access control (MAC) control element (CE) indicating whether on-demand SSB transmission is activated for the one or more SCells. The UE also includes a processor operably coupled to the transceiver. The processor is configured to determine, based on the MAC CE, whether on-demand SSB transmission is activated for an SCell configured with on-demand SSB transmission, and in response to a determination that on-demand SSB transmission is activated for the SCell, measure the on-demand SSB transmission for the SCell.

In another embodiment, a BS is provided. The BS includes a processor, and a transceiver operatively coupled to the processor. The transceiver is configured to transmit, to a UE, a message including a configuration for on-demand synchronization SSB transmission for one or more SCells, and transmit, to the UE, a MAC CE indicating whether on-demand SSB transmission is activated for the one or more SCells.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of periodic SSB transmission according to embodiments of the present disclosure;

FIG. 5 illustrates an example signal flow between a UE and a gNB for triggering on demand SSB transmission for SCell operation according to embodiments of the present disclosure;

FIG. 6 illustrates an example MAC CE format according to embodiments of the present disclosure;

FIG. 7 illustrates another example MAC CE format according to embodiments of the present disclosure;

FIGS. 8A and 8B illustrate another example MAC CE format according to embodiments of the present disclosure;

FIGS. 9A and 9B illustrate another example MAC CE format according to embodiments of the present disclosure;

FIG. 10 illustrates another example signal flow between a UE and a gNB for triggering on demand SSB transmission for SCell operation according to embodiments of the present disclosure;

FIGS. 11A and 11B illustrate another example MAC CE format according to embodiments of the present disclosure;

FIGS. 12A and 12B illustrate another example MAC CE format according to embodiments of the present disclosure;

FIG. 13 illustrates an example method for configuring and activating on demand SSB transmission in SCells according to embodiments of the present disclosure; and

FIG. 14 illustrates another example method for configuring and activating on demand SSB transmission in SCells according to embodiments of the present disclosure.

### DETAILED DESCRIPTION

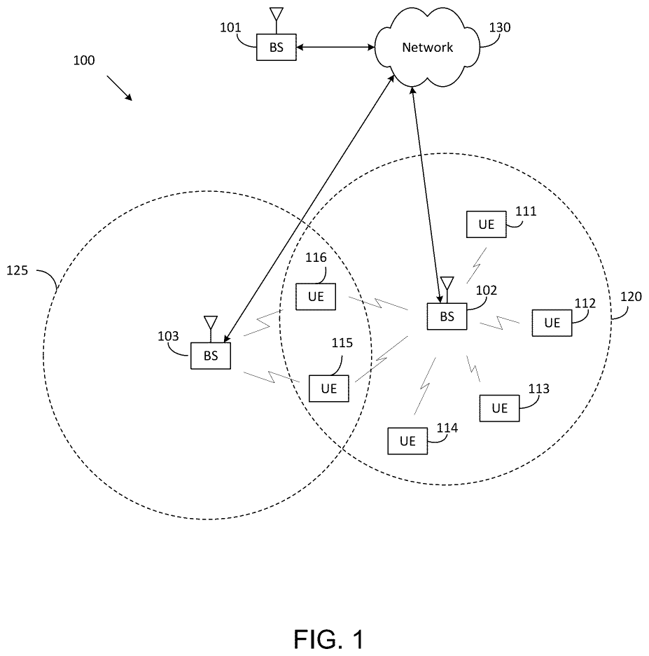

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for configuring and activating on demand SSB transmission in SCells. In certain embodiments, one or more of the gNBs 101-103 includes circuitry, programing, or a combination thereof, to support configuring and activating on demand SSB transmission in SCells in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

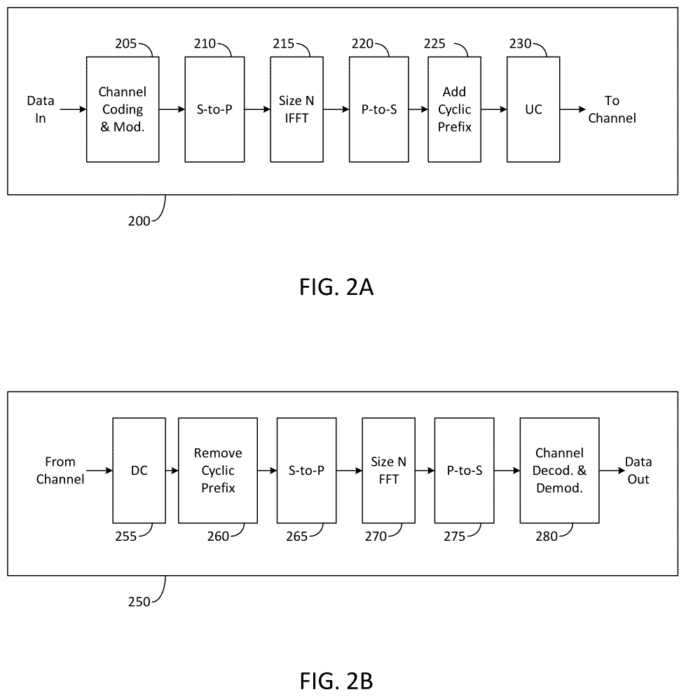

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support configuring and activating on demand SSB transmission in SCells as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

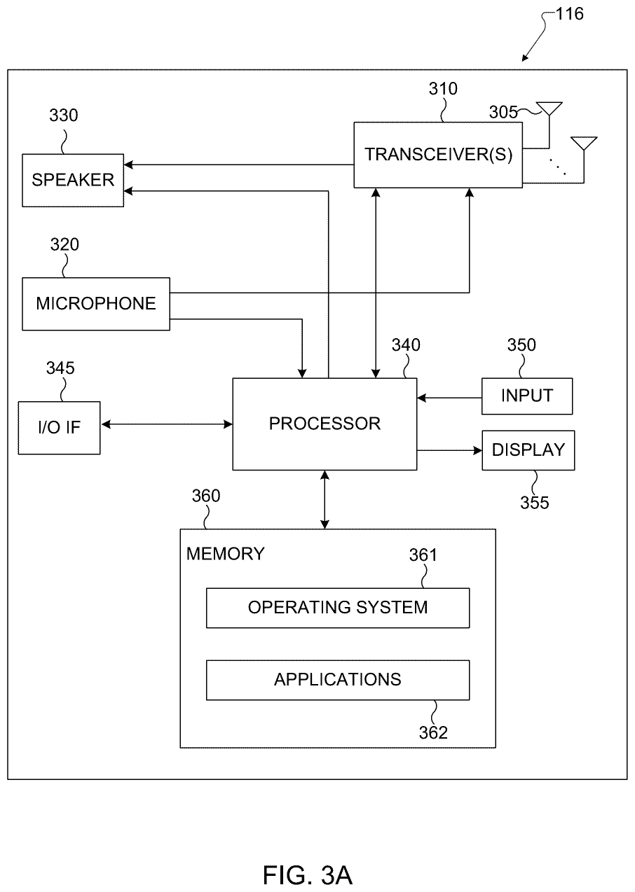

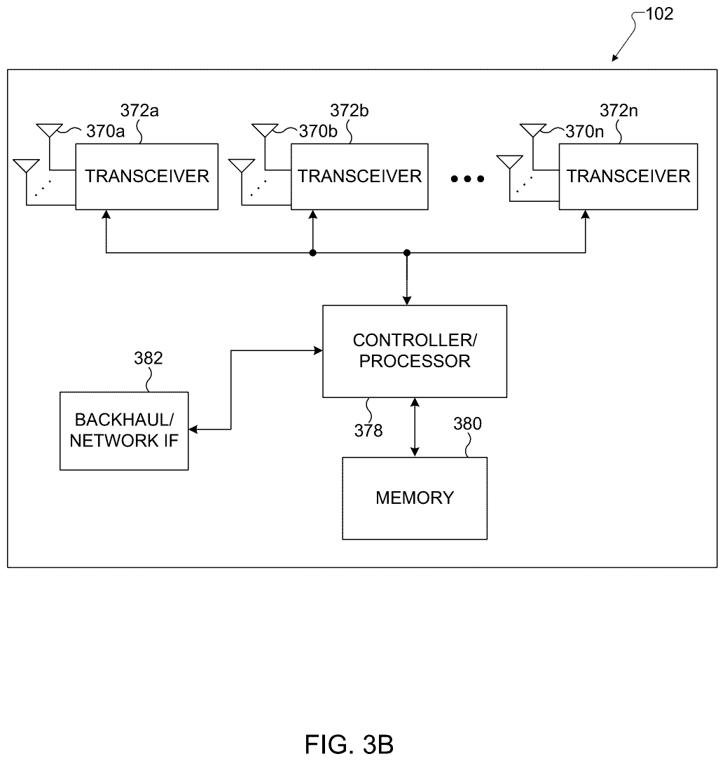

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for configuring and activating on demand SSB transmission in SCells as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support configuring and activating on demand SSB transmission in SCells as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or positioning SIBs (posSIBs) having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in an RRC_CONNECTED state. Several types of RA procedures are supported, such as contention based random access, and contention free random access. Each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0.$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL RS ID (SSB or CSI RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is QCLed with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the UE does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In wireless communication systems, a UE can be configured with SSB based radio resource management (RRM) measurement to discover SCell(s). The UE reports the RRM measurement results to a gNB on the quality of the measured SSB. The gNB can further provide the SCell configuration by RRC to the UE. At the time of configuration, an SCell can be initially activated or deactivated. If the SCell is deactivated, the gNB can activate the SCell via an SCell activation command in a MAC CE. The UE uses the SCell's SSB (or tracking reference signal [TRS] if configured) for automatic gain control (AGC) and synchronization purposes to be ready for transmitting or receiving data on the activated SCell. After the SCell is activated, the UE can still use the SSB to re-synchronize with the SCell, by the UE's implementation.

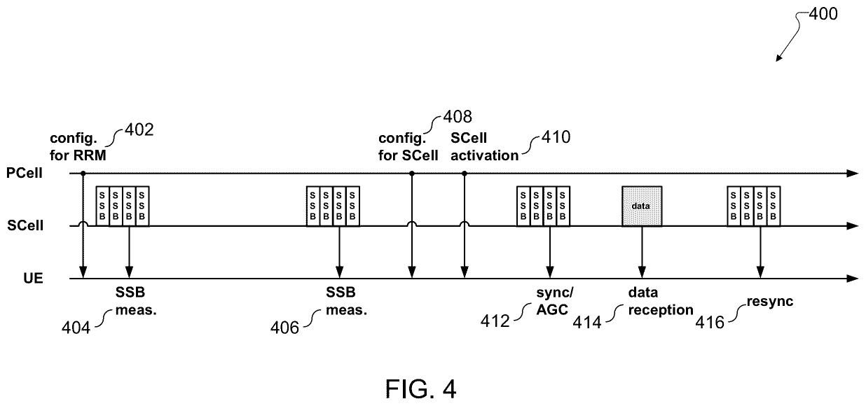

An example of the legacy NR operation of an SCell is shown in FIG. 4, wherein the SSB is transmitted by the SCell and is periodic.

FIG. 4 illustrates an example of periodic SSB transmission 400 according to embodiments of the present disclosure. The embodiment of periodic SSB transmission of FIG. 4 is for illustration only. Different embodiments of periodic SSB transmission could be used without departing from the scope of this disclosure.

In the example of FIG. 4, at time point 402, a UE receives an RRM configuration from a PCell, and begins to monitor periodic SSB transmissions from an SCell. The UE reports the RRM measurement results to a gNB of the PCell on the quality of the measured SSB at time points 404 and 406. At time point 408, the UE receives a configuration for the SCell from the PCell, and at time point 410 the SCell is activated for the UE by the PCell. At time point 412, the UE uses the SSB from the SCell to perform synchronization and AGC. At time point 414, the UE receives data from the SCell. At time point 416, the UE uses the SSB from the SCell to perform resynchronization.

Although FIG. 4 illustrates one example of periodic SSB transmission 400, various changes may be made to FIG. 4. For example, various changes to the periodicity could be made, the number of SSBs per period could be changed, etc. according to particular needs.

In the case of an SSB-less SCell, operation is the same as shown in FIG. 4, except that SSB measurements of a reference serving cell (SpCell or another SCell) are used for the SSB-less SCell.

The periodic transmission of SSBs for the SCell operation affects the network energy consumption. For network energy savings two cases can be considered for on demand SSB transmission in an SCell:
Case #1: The cell does not have always-on periodic SSB transmission. Upon an on demand SSB transmission trigger, SSBs are periodically transmitted.
Case #2: SSBs are periodically transmitted by the cell in an SSB burst/window. On demand SSB transmission can be additionally provided. Note that periodic SSB transmissions can be at a longer periodicity to reduce energy consumption, but this affects performance (e.g., (re) sync/AGC delay, etc.). Additional on demand SSB transmissions can improve performance.

A gNB can trigger on demand SSB transmission for one or more configured SCells. For example:

On demand SSB transmission can be triggered when an SCell is configured to a UE but before the UE receives an SCell activation command.

On demand SSB transmission can be triggered when a UE receives an SCell activation command.

On demand SSB transmission can be triggered after a UE receives an SCell activation command until SCell activation is completed.

On demand SSB transmission can be triggered when or after SCell activation is completed and the SCell is activated.

One of the issues for adequately supporting on demand SSB transmission for SCell operation is defining the signaling mechanism and information to be signaled to the UE when the gNB decides to trigger on demand SSB transmission for the SCell operation. Various embodiments of the present disclosure provide signaling mechanisms for on demand SSB transmission for SCell operation.

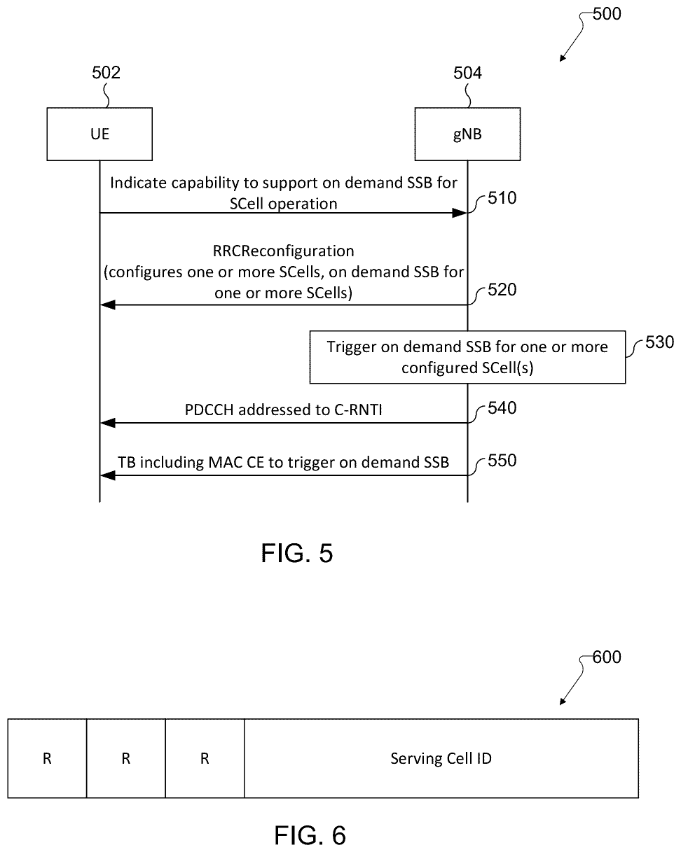

FIG. 5 illustrates an example signal flow 500 between a UE and a gNB for triggering on demand SSB transmission for SCell operation according to embodiments of the present disclosure. An embodiment of the signal flow illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a signal flow between a UE and a gNB for triggering on demand SSB transmission for SCell operation could be used without departing from the scope of this disclosure.

In the example of FIG. 5, signal flow 500 is shown between a UE 502 and a gNB 504. UE 502 is in an RRC_CONNECTED state. Signal flow 500 begins at step 510. At step 510, UE 502 indicates UE 502's capability to support on demand SSB transmission for SCell operation to gNB 504. UE 502's capability can be indicated in an RRC message, UCI, MAC CE, etc. This capability can be a per UE capability, or this capability can be a per frequency capability, or this capability can be a per frequency band capability, or this capability can be a per frequency range (FR1, FR2-1, FR2-2, FR2-NTN, etc.) capability. For example, FR1 can be a frequency range from 410 MHz-7125 MHz, FR2-1 can be a frequency range from 24250 MHz-52600 MHZ, FR2-2 can be a frequency range from 52600 MHZ-71000 MHz, FR2-NTN can be a frequency range from 17300 MHz-30000 MHz, etc.

At step 520, gNB 504 sends an RRCReconfiguration message to UE 502, wherein the message includes a configuration of one or more SCells. The message may indicate whether gNB 504 supports on demand SSB transmission for the configured SCell(s). This indication can be common for all configured SCells, or this indication can be per configured SCell. gNB 504 may indicate support of on demand SSB transmission for zero, one or more configured SCells. For each configured SCell for which gNB 504 supports on demand SSB transmission, gNB 504 may provide/signal (e.g., in an RRCReconfiguration message) the on demand SSB configuration indicating the time (e.g., one or more periodicities) and frequency location(s) (e.g., one or more SSB frequencies) of on demand SSB transmissions. This configuration can be per BWP of the configured SCell(s) or can be common for all BWPs of the configured SCell(s).

At step 530, gNB 504 triggers (i.e., activates or deactivates) on demand SSB transmission for one or more of the configured SCell(s).

At step 540, gNB 504 transmits a PDCCH addressed to a C-RNTI or addressed to an RNTI which can be pre-defined or configured previously in an RRCReconfiguration message. The PDCCH includes scheduling information for a DL transport block (TB).

At step 550, gNB 504 then transmits a TB including a MAC subPDU. The MAC subPDU includes a MAC subheader and MAC CE to trigger (i.e., activate or deactivate) on demand SSB transmission.

Although FIG. 5 illustrates one example signal flow 500 between a UE and a gNB for triggering (i.e., activating or deactivating) on demand SSB transmission for SCell operation, various changes may be made to FIG. 5. For example, while shown as a series of steps, various steps in FIG. 5 could overlap, occur in parallel, occur in a different order, occur any number of times, be omitted, or replaced by other steps.

In some embodiments, the MAC subheader of the MAC CE to trigger on demand SSB transmission may include a logical channel ID (LCID)/extended LCID (eLCID). An LCID/eLCID to indicate that the MAC CE in the MAC subPDU payload is a MAC CE to trigger on demand SSB transmission can be pre-defined. A MAC CE format to trigger (i.e., activate or deactivate) on demand SSB transmission for SCell operation is shown in FIG. 6.

FIG. 6 illustrates an example MAC CE format 600 according to embodiments of the present disclosure. The embodiment of a MAC CE format of FIG. 6 is for illustration only. Different embodiments of a MAC CE format could be used without departing from the scope of this disclosure.

In the example of FIG. 6, MAC CE format 600 includes three R or reserved bits and a 5 bit Serving Cell ID. The Serving Cell ID indicates the identity of the SCell/serving cell for which the MAC CE applies. The Serving Cell ID can be set to the value of ServCellIndex or SCellIndex in the configuration of the SCell for which the MAC CE applies.

Although FIG. 6 illustrates one example MAC CE format 600, various changes may be made to FIG. 6. For example, various changes to number of reserved bits could be made, the size of the Serving Cell ID, etc. according to particular needs.

Upon receiving the TB at step 550, UE 502 may identify that the TB includes a MAC CE with the MAC CE format 600 to trigger on demand SSB transmission based on the LCID/eLCID field in the MAC subheader. UE 502 may then identify the serving cell/SCell for which the MAC CE applies. UE 502 may determine that an on demand SSB transmission is transmitted by a gNB for the serving cell/SCell identified by the Serving Cell ID field in the MAC CE. UE 502 may monitor/measure the on demand SSB transmission in the time/frequency locations configured by the network (e.g., in and RRCReconfiguration message). In some embodiments, the time/frequency location(s) and/or SSB(s) transmitted on demand can be included in the MAC CE.

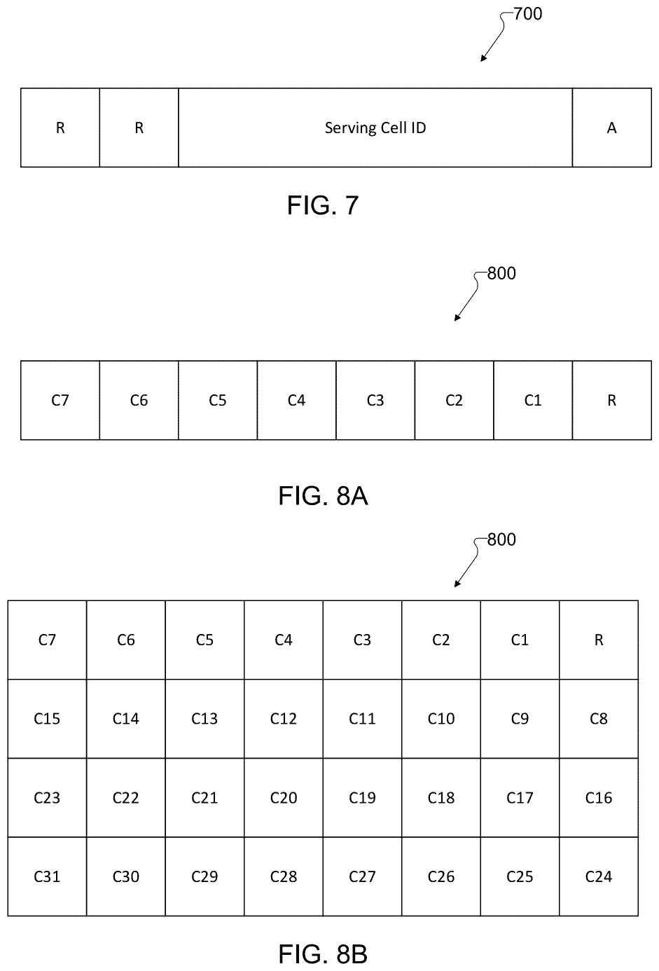

Alternately, in some embodiments, the MAC subheader of the MAC CE to trigger (i.e., activate or deactivate) on demand SSB transmission may include a LCID/eLCID. An LCID/eLCID to indicate that the MAC CE in the MAC subPDU payload is a MAC CE to trigger (i.e., activate or deactivate) on demand SSB transmission can be pre-defined. A MAC CE format to trigger on demand SSB transmission for SCell operation is shown in FIG. 7.

FIG. 7 illustrates another example MAC CE format 700 according to embodiments of the present disclosure. The embodiment of a MAC CE format of FIG. 7 is for illustration only. Different embodiments of a MAC CE format could be used without departing from the scope of this disclosure.

In the example of FIG. 7, MAC CE format 700 includes two R or reserved bits, a 5 bit Serving Cell ID, and a 1 bit ‘A’ field (activation/deactivation). The Serving Cell ID indicates the identity of the SCell/serving cell for which the MAC CE applies. The Serving Cell ID can be set to the value of ServCellIndex or SCellIndex in the configuration of the SCell for which the MAC CE applies. The ‘A’ field may be set to 1 to indicate that on demand SSB transmission for the SCell is activated/triggered/transmitted. The ‘A’ field may be set to 0 to indicate that on demand SSB transmission for the SCell is deactivated/not transmitted.

Although FIG. 7 illustrates one example MAC CE format 700, various changes may be made to FIG. 7. For example, various changes to number of reserved bits could be made, the size of the Serving Cell ID, etc. according to particular needs.

Upon receiving the TB at step 550, UE 502 may identify that the TB includes a MAC CE with the MAC CE format 700 to trigger on demand SSB transmission based on the LCID/eLCID field in the MAC subheader. UE 502 then may identify the serving cell/SCell for which the MAC CE applies. If the ‘A’ field is set to 1, UE 502 may determine that an on demand SSB transmission is transmitted (or activated/triggered) by the gNB for the serving cell/SCell identified by the Serving Cell ID field in the MAC CE. UE 502 may monitor/measure the on demand SSB transmission in the time/frequency locations configured by the network (e.g., in an RRCReconfiguration message). If the ‘A’ field is set to 0, UE 502 may determine that an on demand SSB transmission is not transmitted (or is deactivated) by the gNB for the serving cell/SCell identified by the Serving Cell ID field in the MAC CE. UE 502 may stop monitoring/measuring the on demand SSB transmission in the time/frequency locations configured by the network (e.g., in an RRCReconfiguration message). In some embodiments, the time/frequency location(s) and/or SSB(s) transmitted on demand can be included in the MAC CE.

Alternately, in some embodiments, the MAC subheader may include a LCID/eLCID. The MAC subheader may also include a length field. An LCID/eLCID to indicate that the MAC CE in the MAC subPDU payload is a MAC CE to trigger on demand SSB transmission can be pre-defined. A MAC CE format to trigger on demand SSB transmission for SCell operation is shown in FIGS. 8A and 8B. The LCID/eLCID may be different for the formats shown in FIGS. 8A and 8B.

FIGS. 8A and 8B illustrate another example MAC CE format 800 according to embodiments of the present disclosure. The embodiment of a MAC CE format of FIGS. 8A and 8B is for illustration only. Different embodiments of a MAC CE format could be used without departing from the scope of this disclosure.

In the example of FIG. 8A, MAC CE format 800 includes one R bit and 7 Cj bits. In some embodiments, the format shown in FIG. 8A may be used for a case where the highest ServCellIndex or SCellIndex for which on demand SSB transmission is configured is <8. In some embodiments, the format shown in FIG. 8B may be used for a case where the total number of SCells for which on demand SSB is configured is <8.

In the example of FIG. 8B, MAC CE format 800 includes one R bit and 31 Cj bits. In some embodiments, the format shown in FIG. 8B may be used for a case where the highest ServCellIndex or SCellIndex for which on demand SSB transmission is configured is >=8. In some embodiments, the format shown in FIG. 8B may be used for a case where the total number of SCells for which on demand SSB is configured is >=8. In these embodiments, MAC CE format 800 may include between 8 and 31 Cj bits.

Although FIGS. 8A and 8B illustrate one example MAC CE format 800, various changes may be made to FIGS. 8A and 8B. For example, various changes to number of R bits could be made, the number of Cj bits could vary, etc. according to particular needs.

In some embodiments, for MAC CE format 800, a field Cj may be set to 1 to indicate that on demand SSB transmission for an SCell identified by ServCellIndex j or SCellIndex j is activated/triggered/transmitted. Alternately, in some embodiments, a field Cj may be set to 0 to indicate that on demand SSB transmission for the SCell identified by ServCellIndex j or SCellIndex j is deactivated/not transmitted. ServCellIndex j or SCellIndex j for each SCell is included in the configuration of the SCell received from gNB 504.

Upon receiving the TB at step 550, UE 502 may identify that the TB includes a MAC CE with the MAC CE format 800 to trigger on demand SSB transmission based on the LCID/eLCID field in the MAC subheader. UE 502 then may identify the serving cell(s)/SCell(s) for which the MAC CE applies. If a field Cj is set to 1, UE 502 may determine that an on demand SSB transmission is transmitted (or activated/triggered) by a gNB for the serving cell/SCell identified by ServCellIndex j or SCellIndex j. UE 502 may monitor/measure the on demand SSB transmission for the serving cell/SCell identified by ServCellIndex j or SCellIndex j in the time/frequency locations configured by the network (e.g., in an RRCReconfiguration message). In some embodiments, the time/frequency location(s) and/or SSB(s) transmitted on demand can be included in the MAC CE. The time/frequency location(s) and/or SSB(s) transmitted on demand for each SCell with a field Cj set to 1 can be included sequentially in the MAC CE in increasing order of ServCellIndex j or SCellIndex j. If a field Cj is set to 0, UE 502 may determine that an on demand SSB transmission is not transmitted (or is deactivated) by the gNB for the serving cell/SCell identified by ServCellIndex j or SCellIndex j. UE 502 may stop monitoring/measuring the on demand SSB transmission for the serving cell/SCell identified by ServCellIndex j or SCellIndex j in the time/frequency locations configured by the network (e.g., in an RRCReconfiguration message). In some embodiments, the time/frequency location(s) and/or SSB(s) transmitted on demand can be included in the MAC CE.

In some embodiments, the duration for which on demand SSB is transmitted for an SCell can be included/indicated in the MAC CE or in an RRC message. If a bit Cj is set to 1 and a duration is included/indicated in the MAC CE or RRC message for the serving cell/SCell identified by ServCellIndex j or SCellIndex j, UE 502 may start the on demand SSB activation timer for the serving cell/SCell or UE 502 may restart the on demand SSB activation timer for the serving cell/SCell if the on demand SSB activation timer for the serving cell/SCell is already running or UE 502 may stop the on demand SSB activation timer for the serving cell/SCell if the on demand SSB activation timer is already running or UE 502 may start the on demand SSB activation timer or UE 502 may continue the on demand SSB activation timer for the serving cell/SCell if the on demand SSB activation timer is already running or UE 502 may start the on demand SSB activation timer for the serving cell/SCell if the on demand SSB activation timer for the serving cell/SCell is not running. UE 502 may monitor/measure the on demand SSB transmission for the serving cell/SCell if the on demand SSB activation timer for the serving cell/SCell is running. The on demand SSB activation timer for the serving cell/SCell is stopped when serving cell/SCell is deactivated or when on demand SSB for serving cell/SCell is deactivated.

Alternately, in some embodiments, the MAC subheader may include a LCID/eLCID. An LCID/eLCID to indicate that the MAC CE in the MAC subPDU payload is a MAC CE to trigger on demand SSB transmission can be pre-defined. A MAC CE format to trigger on demand SSB transmission for SCell operation is shown in FIGS. 8A and 8B.

In some embodiments, for MAC CE format 800, SCells configured with on demand SSB transmission are sequentially indexed in increasing order of ServCellIndex or SCellIndex. The indexing begins from 1. For example, three SCells with ServCellIndex or SCellIndex 5, 9 and 15 may be configured with on demand SSB transmission. As a result of indexing, the index j of the SCell with ServCellIndex or SCellIndex 5 is 1, the index j of the SCell with ServCellIndex or SCellIndex 9 is 2, and the index j of the SCell with ServCellIndex or SCellIndex 15 is 3. In some embodiments, if there is an SpCell/PCell configured with on demand SSB, the SpCell/PCell's index j is set to 0 and the R bit is used as CO for the SpCell/PCell. A single octet Cj bitmap may be included in the MAC CE format 800 if the total number of SCells for which on demand SSB transmission is configured is greater than 0 and less than 8. A two octets Cj bitmap may be included in the MAC CE format 800 if the total number of SCells for which on demand SSB transmission is configured is greater than 7 and less than 16. A three octets Cj bitmap may be included in the MAC CE format 800 if the total number of SCells for which on demand SSB transmission is configured is greater than 15 and less than 24. A four octets Cj bitmap may include in the MAC CE format 800 if the total number of SCells for which on demand SSB transmission is configured is greater than 23. A field Cj may be set to 1 to indicate that an on demand SSB transmission for the j^{th} SCell configured with on demand SSB transmission is activated/triggered/transmitted. A field Cj may be set to 0 to indicate that the on demand SSB transmission for the j^{th} SCell configured with on demand SSB transmission is deactivated/not transmitted.

Alternately, in some embodiments, a single octet Cj bitmap may be included in the MAC CE format 800 if the total number of serving cells (SCells+SpCell/PCell) for which on demand SSB transmission is configured is greater than 0 and less than 9. A two octets Cj bitmap may be included in the MAC CE format 800 if the total number of serving cells (SCells+SpCell/PCell) for which on demand SSB transmission is configured is greater than 8 and less than 17. A three octets Cj bitmap may be included in the MAC CE format 800 if the total number of serving cells (SCells+SpCell/PCell) for which on demand SSB transmission is configured is greater than 16 and less than 25. A four octets Cj bitmap may include in the MAC CE format 800 if the total number of serving cells (SCells+SpCell/PCell) for which on demand SSB transmission is configured is greater than 24. A field Cj may be set to 1 to indicate that an on demand SSB transmission for the j^{th} SCell configured with on demand SSB transmission is activated/triggered/transmitted. A field Cj may be set to 0 to indicate that the on demand SSB transmission for the j^{th} serving cell configured with on demand SSB transmission is deactivated/not transmitted.

Upon receiving the TB at step 550, UE 502 may identify that the TB includes a MAC CE with the MAC CE format 800 to trigger on demand SSB transmission based on the LCID/eLCID field in the MAC subheader. UE 502 then may identify the serving cell(s)/SCell(s) for which the MAC CE applies. If a field Cj is set to 1, UE 502 may determine that an on demand SSB transmission is transmitted (or activated/triggered) by a gNB for the j^{th} serving cell/SCell configured with on demand SSB transmission. UE 502 may monitor/measure the on demand SSB transmission for the j^{th} serving cell/SCell configured with on demand SSB transmission in the time/frequency locations configured by the network (e.g., in an RRCReconfiguration message). In some embodiments, the time/frequency location(s) and/or SSB(s) transmitted on demand can be included in the MAC CE. The time/frequency location(s) and/or SSB(s) transmitted on demand for each SCell with a field Cj set to 1 can be included sequentially in the MAC CE in increasing order of j. If a field Cj is set to 0, UE 502 may determine that an on demand SSB transmission is not transmitted (or is deactivated) by the gNB for the j^{th} serving cell/SCell configured with on demand SSB transmission. UE 502 may stop monitoring/measuring the on demand SSB transmission for the j^{th} serving cell/SCell configured with on demand SSB in the time/frequency locations configured by the network (e.g., in an RRCReconfiguration message).

In some embodiments, the duration for which on demand SSB is transmitted for SCell can be included/indicated in the MAC CE or in an RRC message. If a bit Cj is set to 1 and a duration is included/indicated in the MAC CE or RRC message for the j^{th} serving cell/SCell, UE 502 may start the on demand SSB activation timer for the serving cell/SCell or UE 502 may restart the on demand SSB activation timer for the serving cell/SCell if the on demand SSB activation timer for the serving cell/SCell is already running or UE may stop the on demand SSB activation timer for the serving cell/SCell if the on demand SSB activation timer is already running or UE 502 may start the on demand SSB activation timer or UE 502 may continue the on demand SSB activation timer for the serving cell/SCell if the on demand SSB activation timer is already running or UE 502 may start the on demand SSB activation timer for the serving cell/SCell if the on demand SSB activation timer for the serving cell/SCell is not running. UE 502 may monitor/measure the on demand SSB transmission for the serving cell/SCell if the on demand SSB activation timer for the serving cell/SCell is running. The on demand SSB activation timer for the serving cell/SCell is stopped when serving cell/SCell is deactivated or when on demand SSB for serving cell/SCell is deactivated.

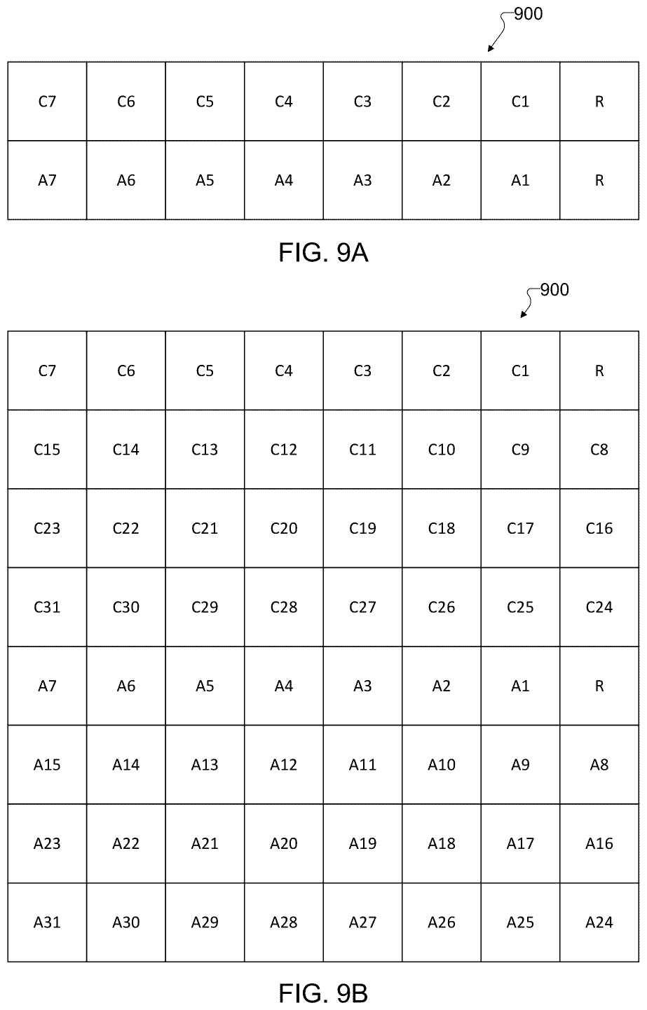

Alternately, in some embodiments, the MAC subheader may include a LCID/eLCID. The MAC subheader may also include a length field. An LCID/eLCID to indicate that the MAC CE in the MAC subPDU payload is a MAC CE to trigger on demand SSB transmission can be pre-defined. A MAC CE format to trigger on demand SSB transmission for SCell operation is shown in FIGS. 9A and 9B. The LCID/eLCID may be different for the formats shown in FIGS. 9A and 9B.

FIGS. 9A and 9B illustrate another example MAC CE format 900 according to embodiments of the present disclosure. The embodiment of a MAC CE format of FIGS. 9A and 9B is for illustration only. Different embodiments of a MAC CE format could be used without departing from the scope of this disclosure.

In the example of FIG. 9A, MAC CE format 900 includes a first octet including one R bit and 7 Cj bits, and a second octet including one R bit, and 7 Aj (or Ak) bits. In some embodiments, the format shown in FIG. 9A may be used for a case where a highest ServCellIndex or SCellIndex for which on demand SSB transmission is configured is <8.

In the example of FIG. 9B, MAC CE format 900 includes four octets including one R bit and 31 Cj bits, and in some embodiments another four octets including one R bit, and 31 Aj (or Ak) bits. In some embodiments, the additional four octets may include 32 Ak bits and no R bits (i.e., A0 replaces R).

In some embodiments, the format shown in FIG. 9B may be used for a case where highest ServCellIndex or SCellIndex for which on demand SSB transmission is configured is >=8.

Although FIGS. 9A and 9B illustrate one example MAC CE format 900, various changes may be made to FIGS. 9A and 9B. For example, various changes to number of R bits could be made, the number of Cj bits could vary, etc. according to particular needs.

In some embodiments, for MAC CE format 900, a field Cj may be set to 1 to indicate that on demand SSB transmission for an SCell identified by ServCellIndex j or SCellIndex j is indicated by bit Aj. Alternately, in some embodiments, a field Cj may be set to 0 to indicate that on demand SSB transmission for the SCell identified by ServCellIndex j or SCellIndex j is not indicated in this MAC CE. In some embodiments, a field Aj may be set to 1 to indicate that on demand SSB transmission for the SCell identified by ServCellIndex j or SCellIndex j is activated/triggered/transmitted. Alternately, in some embodiments, a field Aj may be set to 0 to indicate that on demand SSB transmission for the SCell identified by ServCellIndex j or SCellIndex j is deactivated/not transmitted.

Upon receiving the TB at step 550, UE 502 may identify that the TB includes a MAC CE to trigger on demand SSB transmission based on the LCID/eLCID field in the MAC subheader. UE 502 then may identify the serving cell(s)/SCell(s) for which the MAC CE applies. If a field Cj is set to 1, UE 502 determines that the status of on demand SSB transmission for an SCell identified by ServCellIndex j or SCellIndex j is indicated by a bit Aj. If a field Aj is set to 1, UE 502 may determine that an on demand SSB transmission is transmitted (or activated/triggered) by a gNB for the serving cell/SCell identified by ServCellIndex j or SCellIndex j. UE 502 may monitor/measure the on demand SSB transmission for the serving cell/SCell identified by ServCellIndex j or SCellIndex j in the time/frequency locations configured by the network (e.g., in an RRCReconfiguration message). In some embodiments, the time/frequency location(s) and/or SSB(s) transmitted on demand can be included in the MAC CE for a serving cell/SCell for which Aj is set to 1. The time/frequency location(s) and/or SSB(s) transmitted on demand for each SCell with a field Aj set to 1 can be included sequentially in the MAC CE in increasing order of ServCellIndex j or SCellIndex j. If a field Aj is set to 0, UE 502 may determine that on an demand SSB transmission is not transmitted (or is deactivated) by the gNB for the serving cell/SCell identified by ServCellIndex j or SCellIndex j. UE 502 may stop monitoring/measuring the on demand SSB transmission for the serving cell/SCell identified by ServCellIndex j or SCellIndex j in the time/frequency locations configured by the network (e.g., in an RRCReconfiguration message). In some embodiments, the time/frequency location(s) and/or SSB(s) transmitted on demand may not be included in the MAC CE for a serving cell/SCell for which Cj or Aj is set to 0.

In some embodiments, the duration for which on demand SSB is transmitted for an SCell can be included/indicated in the MAC CE or in an RRC message. If a bit Aj is set to 1 and a duration is included/indicated in the MAC CE or RRC message for the serving cell/SCell for which the bit Aj applies, UE 502 may start the on demand SSB activation timer for the serving cell/SCell or UE 502 may restart the on demand SSB activation timer for the serving cell/SCell if the on demand SSB activation timer for the serving cell/SCell is already running or UE 502 may stop the on demand SSB activation timer for the serving cell/SCell if the on demand SSB activation timer is already running or UE 502 may start the on demand SSB activation timer or UE 502 may continue the on demand SSB activation timer for the serving cell/SCell if the on demand SSB activation timer is already running or UE 502 may start the on demand SSB activation timer for the serving cell/SCell if the on demand SSB activation timer for the serving cell/SCell is not running. UE 502 may monitor/measure the on demand SSB transmission for the serving cell/SCell if the on demand SSB activation timer for the serving cell/SCell is running. The on demand SSB activation timer for the serving cell/SCell is stopped when serving cell/SCell is deactivated or when on demand SSB for serving cell/SCell is deactivated.

Alternately, in some embodiments, the MAC subheader may include an LCID/eLCID. The MAC subheader may also include a length field. An LCID/eLCID to indicate that the MAC CE in the MAC subPDU payload is a MAC CE to trigger on demand SSB transmission can be pre-defined. A MAC CE format to trigger on demand SSB transmission for SCell operation is shown in FIGS. 9A and 9B. The LCID/eLCID may be different for the formats shown in FIGS. 9A and 9B.

In some embodiments, for MAC CE format 900, a field Cj may be set to 1 to indicate that on demand SSB transmission for an SCell identified by ServCellIndex j or SCellIndex j is indicated in the MAC CE. Alternately, in some embodiments, a field Cj may be set to 0 to indicate that the status of on demand SSB transmission for the SCell identified by ServCellIndex j or SCellIndex j is not indicated in this MAC CE.

In some embodiments, if the “R” bit in an Ak bit map is used as A0, SCells for which a field Cj is set to 1 are sequentially indexed starting from zero in increasing order of ServCellIndex or SCellIndex. In some embodiments, a single octet Ak bitmap may be included in MAC CE format 900 if the total number of SCells for which a bit Cj is set to 1 is greater than 0 and less than 9. In some embodiments, a two octets Ak bitmap may be included in MAC CE format 900 if the total number of SCells for which a bit Cj is set to 1 is greater than 8 and less than 17. In some embodiments, a three octets Ak bitmap may be included in MAC CE format 900 if the total number of SCells for which a bit Cj is set to 1 is greater than 16 and less than 25. In some embodiments, a four octets Ak bitmap may be included in MAC CE format 900 if the total number of SCells for which a bit Cj is set to 1 is configured is greater than 24. Otherwise, if the “R” bit in the Ak bit map is not used as A0, SCells for which Cj field is set to 1 are sequentially indexed starting from one in increasing order of ServCellIndex or SCellIndex. In some embodiments, a single octet Ak bitmap may be included in MAC CE format 900 if the total number of SCells for which a bit Cj is set to 1 is greater than 0 and less than 8. In some embodiments, a two octets Ak bitmap may be included in MAC CE format 900 if the total number of SCells for which a bit Cj is set to 1 is greater than 7 and less than 16. In some embodiments, a three octets Ak bitmap may be included in MAC CE format 900 if the total number of SCells for which a bit Cj is set to 1 is greater than 15 and less than 24. In some embodiments, a four octets Ak bitmap may be included in MAC CE format 900 if the total number of SCells for which a bit Cj is set to 1 is configured is greater than 23.

In some embodiments, a field Ak set to 1 may indicate that on demand SSB transmission for a kth SCell for which a Cj bit is set to 1 is activated/triggered/transmitted. In some embodiments, a field Ak set to 0 may indicate that on demand SSB transmission for the kth SCell for which a bit Cj is set to 1 is deactivated/not transmitted.

In some embodiments, the duration for which on demand SSB is transmitted for an SCell can be included/indicated in the MAC CE or in an RRC message. If a bit Ak is set to 1 and a duration is included/indicated in the MAC CE or RRC message for the serving cell/SCell for which the bit Ak applies, UE 502 may start the on demand SSB activation timer for the serving cell/SCell or UE 502 may restart the on demand SSB activation timer for the serving cell/SCell if the on demand SSB activation timer for the serving cell/SCell is already running or UE 502 may stop the on demand SSB activation timer for the serving cell/SCell if the on demand SSB activation timer is already running or UE 502 may start the on demand SSB activation timer or UE 502 may continue the on demand SSB activation timer for the serving cell/SCell if the on demand SSB activation timer is already running or UE 502 may start the on demand SSB activation timer for the serving cell/SCell if the on demand SSB activation timer for the serving cell/SCell is not running. UE 502 may monitor/measure the on demand SSB transmission for the serving cell/SCell if the on demand SSB activation timer for the serving cell/SCell is running. The on demand SSB activation timer for the serving cell/SCell is stopped when serving cell/SCell is deactivated or when on demand SSB for serving cell/SCell is deactivated.

Upon receiving the TB at step 550, UE 502 may identify that the TB includes a MAC CE to trigger on demand SSB transmission based on the LCID/eLCID field in the MAC subheader. UE 502 then may identify the serving cell(s)/SCell(s) for which the MAC CE applies. If a field Cj is set to 1, UE 502 may determine that the status of on demand SSB transmission for an SCell identified by ServCellIndex j or SCellIndex j is indicated in the MAC CE. If a field Ak is set to 1, UE 502 may determine that an on demand SSB transmission is transmitted (activated/triggered) by a gNB for the kth serving cell/SCell for which the field Cj is set to 1. UE 502 may monitor/measure the on demand SSB transmission for the kth serving cell/SCell for which the field Cj is set to 1 in the time/frequency locations configured by the network (e.g., in an RRCReconfiguration message) and Ak is set to 1. In some embodiments, the time/frequency location(s) and/or SSB(s) transmitted on demand can be included in the MAC CE. The time/frequency location(s) and/or SSB(s) transmitted on demand for each SCell with a field Ak set to 1 can be included sequentially in the MAC CE in increasing order of k. If a field Ak is set to 0, UE 502 may determine that an on demand SSB transmission is not transmitted (or is deactivated) by the gNB for the kth serving cell/SCell for which the field Cj is set to 1. UE 502 may stop monitoring/measuring the on demand SSB transmission for the kth serving cell/SCell for which the field Cj is set to 1 in the time/frequency locations configured by the network (e.g., in an RRCReconfiguration message).

In some embodiments, an RRCReconfiguration message (e.g., as transmitted at step 520) may configure one or more SCells. The RRCReconfiguration message may indicate an SCell state as activated for one or more configured SCells. For an SCell configured in the message and with the SCell state as activated (or for an SCell configured in the message), if the on demand SSB transmission for SCell operation is configured for this SCell, UE 502 may determine/assume that on demand SSB transmission is transmitted (activated/triggered) by a gNB for the SCell. UE 502 may monitor/measure the on demand SSB transmission for the SCell in the time/frequency locations configured by the network (e.g., in an RRCReconfiguration message).

In some embodiments, an RRCReconfiguration message (e.g., as transmitted at step 520) may configure one or more SCells. The RRCReconfiguration message may indicate an SCell state as activated for one or more configured SCells. For an SCell configured in the message and with the SCell state as activated (or for an SCell configured in the message), if the on demand SSB transmission for SCell operation is configured for this SCell, the RRCReconfiguration message may indicate whether an on demand SSB is transmitted (activated/triggered) by a gNB for the SCell or not. If the RRCReconfiguration message indicates that on an demand SSB is transmitted (activated/triggered) by the gNB for the SCell, UE 502 may monitor/measure the on demand SSB transmission for the SCell in the time/frequency locations configured by the network (e.g., in an RRCReconfiguration message).

In some embodiments, an RRCReconfiguration message (e.g., as transmitted at step 520) may configure one or more SCells. For an SCell configured in the message, if the on demand SSB transmission for SCell operation is configured for this SCell, the RRCReconfiguration message may indicate that on demand SSB is transmitted (activated/triggered) by a gNB for the SCell when the SCell is activated. In this case upon receiving the activation command for the SCell or if the RRCReconfiguration message indicates that the SCell state for the SCell is activated, on demand SSB transmission is considered as being transmitted (activated/triggered) by the gNB for the SCell and UE 502 may monitor/measure the on demand SSB transmission for the SCell in the time/frequency locations configured by the network (e.g., in an RRCReconfiguration message).

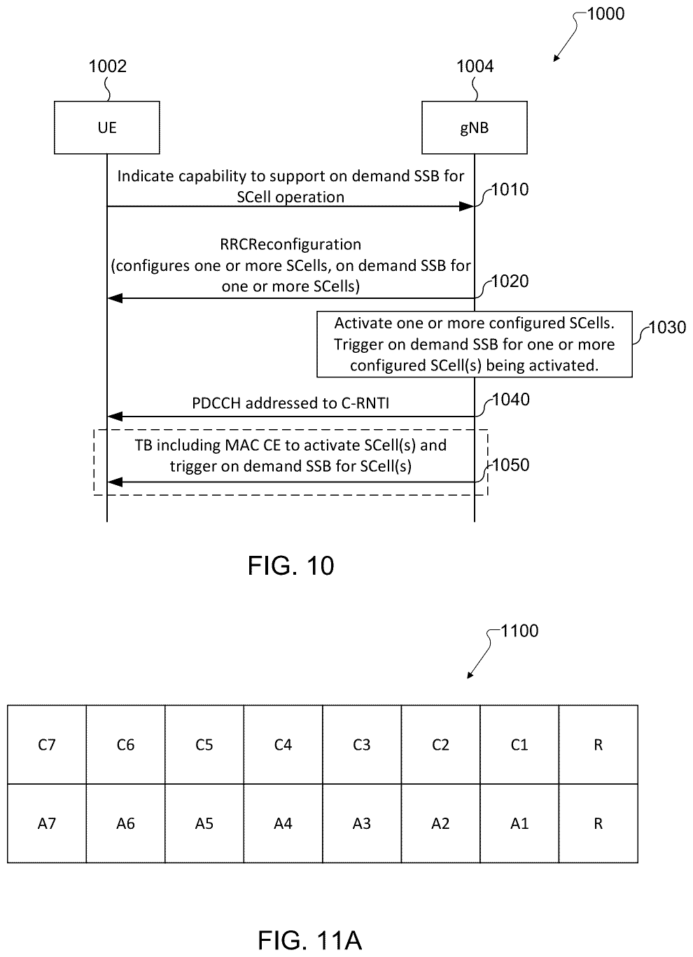

FIG. 10 illustrates another example signal flow 1000 between a UE and a gNB for triggering on demand SSB transmission for SCell operation according to embodiments of the present disclosure. An embodiment of the signal flow illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a signal flow between a UE and a gNB for triggering on demand SSB transmission for SCell operation could be used without departing from the scope of this disclosure.

In the example of FIG. 10, signal flow 1000 is between a UE 1002 and a gNB 1004. UE 1002 is in an RRC_CONNECTED state.

Signal flow 1000 begins at step 1010. At step 1010, UE 1002 indicates UE 1002's capability to support on demand SSB transmission for SCell operation. UE 502's capability can be indicated in an RRC message, UCI, MAC CE, etc. This capability can be a per UE capability, or this capability can be a per frequency capability, or this capability can be a per frequency band capability, or this capability can be a per frequency range (FR1, FR2-1, FR2-2, FR2-NTN, etc.) capability. For example, FR1 can be a frequency range from 410 MHz-7125 MHz, FR2-1 can be a frequency range from 24250 MHz-52600 MHZ, FR2-2 can be a frequency range from 52600 MHz-71000 MHz, FR2-NTN can be frequency range from 17300 MHz-30000 MHz, etc.

At step 1020, gNB 1004 sends an RRCReconfiguration message, wherein the message includes a configuration of one or more SCells. The message may indicate whether gNB 1004 supports on demand SSB transmission for the configured SCell(s). This indication can be common for all configured SCells, or this indication can be per configured SCell. gNB 1004 may indicate support of on demand SSB transmission for zero, one or more configured SCells. For each configured SCell for which gNB 1004 supports on demand SSB transmission, gNB 1004 may provide/signal (e.g., in an RRCReconfiguration message) the configuration indicating time and frequency location(s) of on demand SSB transmissions. This configuration can be per BWP of the configured SCell(s) or can be common for all BWPs of the configured SCell(s).

At step 1030, gNB 1004 determines to activate one or more SCells and triggers on demand SSB transmission for one or more configured SCell(s).

At step 1040, gNB 1004 transmits a PDCCH addressed to a C-RNTI or addressed to an a RNTI which can be pre-defined or configured previously in an RRCReconfiguration message. The PDCCH includes scheduling information for a DL TB.

At step 1050, gNB 1004 then transmits a TB including a MAC subPDU. The MAC subPDU includes a MAC subheader and MAC CE which triggers on demand SSB transmission for one or more SCell(s) and also activates one or more SCell(s). This MAC CE can also be referred to as an Enhanced SCell Activation/Deactivation MAC CE.

Although FIG. 10 illustrates one example signal flow 1000 between a UE and a gNB for triggering on demand SSB transmission for SCell operation, various changes may be made to FIG. 10. For example, while shown as a series of steps, various steps in FIG. 10 could overlap, occur in parallel, occur in a different order, occur any number of times, be omitted, or replaced by other steps.

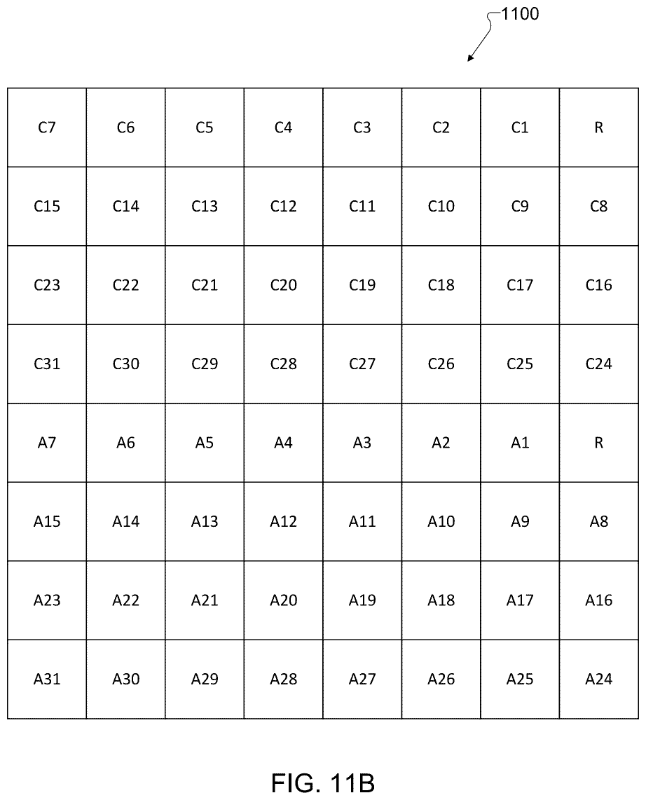

In some embodiments, the MAC subheader may include an LCID/eLCID. The MAC subheader may also include a length field. An LCID/eLCID to indicate that the MAC CE in the MAC subPDU payload is an Enhanced SCell Activation/Deactivation MAC CE to activate and trigger on demand SSB transmission can be pre-defined. A MAC CE format to activate and trigger on demand SSB transmission for SCell operation is shown in FIGS. 11A and 11B. The LCID/eLCID may be different for the formats shown in FIGS. 11A and 11B.

FIGS. 11A and 11B illustrate another example MAC CE format 1100 according to embodiments of the present disclosure. The embodiment of a MAC CE format of FIGS. 11A and 11B is for illustration only. Different embodiments of a MAC CE format could be used without departing from the scope of this disclosure.

In the example of FIG. 11A, MAC CE format 1100 includes a first octet including one R bit and 7 Cj bits, and a second octet including one R bit, and 7 Aj (or Ak) bits.

In the example of FIG. 11B, MAC CE format 1100 includes four octets including one R bit and 31 Cj bits, and in some embodiments another four octets including one R bit, and 31 Aj (or Ak) bits.

Although FIGS. 11A and 11B illustrate one example MAC CE format 1100, various changes may be made to FIGS. 11A and 11B. For example, various changes to number of R bits could be made, the number of Cj bits could vary, etc. according to particular needs.

In some embodiments, for MAC CE format 1100, if there is an SCell configured for the MAC entity with SCellIndex j, a field Cj may indicate the activation/deactivation status of the SCell with SCellIndex j. A field Cj may be set to 1 to indicate that an SCell identified by SCellIndex j is activated. A field Cj may be set to 0 to indicate that and SCell identified by SCellIndex j is not activated (or deactivated). In some embodiments, if there is an SCell configured with on demand SSB transmission for the MAC entity with SCellIndex j, a field Aj may indicate the activation/deactivation status of on demand SSB transmission for the SCell with SCellIndex j. A field Aj may be set to 1 to indicate that on demand SSB transmission for the SCell identified by SCellIndex j is activated/triggered/transmitted. A field Aj may be set to 0 to indicate that on demand SSB transmission for the SCell identified by ServCellIndex j or SCellIndex j is deactivated/not transmitted.

Upon receiving the TB at step 1050, UE 1002 may identify that the TB includes an enhanced SCell Activation/Deactivation MAC CE. If a field Cj is set to 1, UE 1002 may determine that the field Cj is an activation command for an SCell identified by SCellIndex j. If a field Cj is set to 0, UE 1002 may determine that the field Cj is a deactivation command for the SCell identified by SCellIndex j. If a field Aj is set to 1, UE 1002 may determine that an on demand SSB transmission is transmitted (activated/triggered) by gNB 1004 for the SCell identified by SCellIndex j. UE 1002 may monitor/measure the on demand SSB transmission for the SCell identified by SCellIndex j in the time/frequency locations configured by the network (e.g., in an RRCReconfiguration message). In some embodiments, the time/frequency location(s) and/or SSB(s) transmitted on demand can be included in the MAC CE. The time/frequency location(s) and/or SSB(s) transmitted on demand for each SCell with a field Aj set to 1 can be included sequentially in the MAC CE in increasing order of j. If a field Aj is set to 0, UE 1002 may determine that an on demand SSB is not transmitted (or deactivated) by gNB 1004 for the SCell identified by SCellIndex j. UE 1002 may stop monitoring/measuring the on demand SSB transmission for the SCell identified by SCellIndex j in the time/frequency locations configured by the network (e.g., in an RRCReconfiguration message).

Alternately, in some embodiments, the MAC subheader may include a LCID/eLCID. The MAC subheader may also include a length field. An LCID/eLCID to indicate that the MAC CE in the MAC subPDU payload is an Enhanced SCell Activation/Deactivation MAC CE to activate and trigger on demand SSB transmission can be pre-defined. A MAC CE format to trigger on demand SSB transmission for SCell operation is shown in FIGS. 11A and 11B. The LCID/eLCID may be different for the formats shown in FIGS. 11A and 11B.

In some embodiments, for MAC CE format 1100, if there is an SCell configured for the MAC entity with SCellIndex j, a field Cj may indicate the activation/deactivation status of the SCell with SCellIndex j. A field set to 1 may indicate that an SCell identified by SCellIndex j is activated. A field Cj set to 0 may indicate that the SCell identified by SCellIndex j is not activated (or deactivated).

In some embodiments, SCells for which a field Cj is set to 1 are sequentially indexed starting from one in increasing order of SCellIndex. A single octet Ak bitmap may be included in the MAC CE format 1100 if the total number of SCells for which a bit Cj is set to 1 is greater than 0 and less than 8. A two octets Ak bitmap may be included in the MAC CE format 1100 if the total number of SCells for which a bit Cj is set to 1 is greater than 7 and less than 16. A three octets Ak bitmap may be included in the MAC CE format 1100 if the total number of SCells for which a bit Cj is set to 1 is greater than 15 and less than 24. A four octets Ak bitmap may be included in the MAC CE format 1100 if the total number of SCells for which a bit Cj is set to 1 is configured is greater than 23. A field Ak may be set to 1 to indicate that on demand SSB transmission for the kth SCell for which bit Cj is set to 1 is activated/triggered/transmitted. An Ak field may be set to 0 to indicate that on demand SSB transmission for the kth SCell for which a bit Cj is set to 1 is deactivated/not transmitted.

Upon receiving the TB at step 1050, UE 1002 may identify that the TB includes a MAC CE to trigger on demand SSB transmission based on the LCID/eLCID field in the MAC subheader. UE 1002 then may identify the serving cell(s)/SCell(s) for which the MAC CE applies. If a field Cj is set to 1, UE 1002 may determine that the field Cj is an activation command for an SCell identified by SCellIndex j. If a field Cj is set to 0, UE 1002 may determine that the field Cj is an deactivation command for the SCell identified by SCellIndex j. If a field Ak is set to 1, UE 1002 may determine that on demand SSB is transmitted (activated/triggered) by gNB 1004 for the kth SCell for which a field Cj is set to 1. UE 1002 may monitor/measure the on demand SSB transmission for the kth SCell for which a field Cj is set to 1 in the time/frequency locations configured by the network (e.g., in an RRCReconfiguration message). In some embodiments, the time/frequency location(s) and/or SSB(s) transmitted on demand can be included in the MAC CE. The time/frequency location(s) and/or SSB(s) transmitted on demand for each SCell with an Ak field is set to 1 can be included sequentially in the MAC CE in increasing order of k. If a field Ak is set to 0, UE 1002 may determine that an on demand SSB is not transmitted (or deactivated) by gNB 1004 for the kth SCell for which a field Cj is set to 1. The UE stops to monitor/measure the on demand SSB transmission for the kth SCell for which a Cj field is set to 1 in the time/frequency locations configured by the network (e.g., in an RRCReconfiguration message).

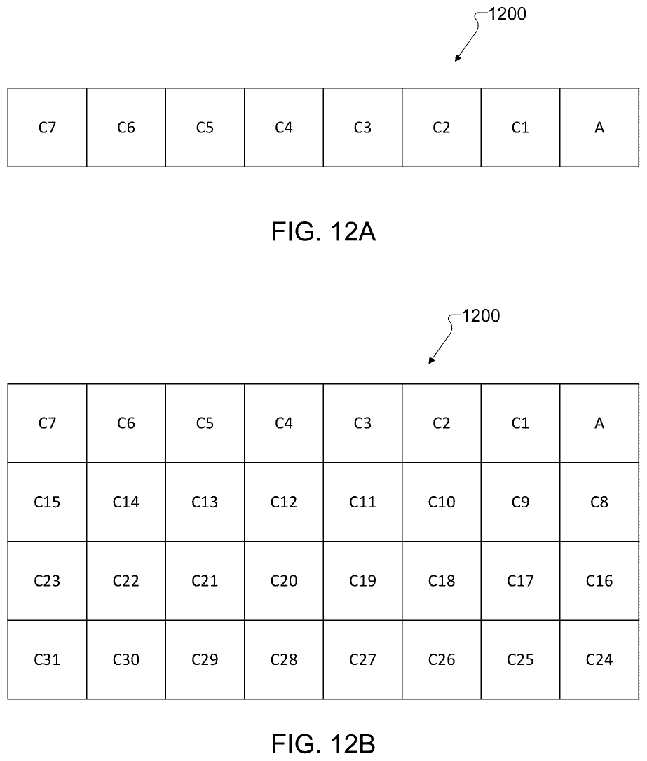

Alternately, in some embodiments, the MAC subheader may include a LCID/eLCID. The MAC subheader may also include a length field. An LCID/eLCID to indicate that the MAC CE in the MAC subPDU payload is an (Enhanced) SCell Activation/Deactivation MAC CE to activate the SCell and trigger on demand SSB transmission can be pre-defined. A MAC CE format to trigger on demand SSB transmission for SCell operation is shown in FIGS. 12A and 12B. The LCID/eLCID may be different for the formats shown in FIGS. 12A and 12B.

FIGS. 12A and 12B illustrate an example MAC CE format 1200 according to embodiments of the present disclosure. The embodiment of a MAC CE format of FIGS. 12A and 12B is for illustration only. Different embodiments of a MAC CE format could be used without departing from the scope of this disclosure.

In the example of FIG. 12A, MAC CE format 1200 includes one A bit and 7 Cj bits.

In the example of FIG. 12B, MAC CE format 1200 includes one R bit and 31 Cj bits.

Although FIGS. 12A and 12B illustrate one example MAC CE format 1200, various changes may be made to FIGS. 12A and 12B. For example, various changes to number of A bits could be made, the number of Cj bits could vary, etc. according to particular needs.

In some embodiments, for MAC CE format 1200, if there is an SCell configured for the MAC entity with SCellIndex j, a field Cj may indicate the activation/deactivation status of the SCell with SCellIndex j. A field Cj set to 1 may indicate that the SCell identified by SCellIndex j is activated. A field Cj set to 0 may indicate that the SCell identified by SCellIndex j is not activated (or deactivated). The ‘A’ field set to 1 may indicate that on demand SSB transmission for SCell(s) for which a bit Cj is set to 1 and for which on demand SSB transmission is configured (or the activated/status is activated in RRCReconfiguration or for which the RRC indicates that activation is via the MAC CE), is activated/triggered/transmitted. The ‘A’ field set to 0 may indicate that on demand SSB transmission for SCell(s) for which a bit Cj is set to 1 and on demand SSB transmission is configured is deactivated/not transmitted.

Upon receiving the TB at step 1050, UE 1002 may identify that the TB includes a MAC CE to trigger on demand SSB transmission based on the LCID/eLCID field in the MAC subheader. UE 1002 then may identify the serving cell(s)/SCell(s) for which the MAC CE applies.

If a field Cj is set to 1, UE 1002 may determine that the field Cj is an activation command for the SCell identified by SCellIndex j. If the field Cj is set to 0, UE 1002 may determine that the field Cj is a deactivation command for the SCell identified by SCellIndex j. If the ‘A’ field is set to 1, UE 1002 may determine/assume/consider that an on demand SSB transmission is transmitted (activated/triggered) by gNB 1004 for the SCell(s) for which the field Cj is set to 1 and for which on demand SSB transmission is configured (or activated/status is activated in RRCReconfiguration or for which RRC indicates that activation is via the MAC CE). UE 1002 may monitor/measure the on demand SSB transmission for the SCell(s) for which a field Cj is set to 1 and for which on demand SSB transmission is configured (or activated/status is activated in RRCReconfiguration or for which RRC indicates that activation is via the MAC CE), in the time/frequency locations configured by the network (e.g., in an RRCReconfiguration message). In some embodiments, the time/frequency location(s) and/or SSB(s) transmitted on demand can be included in the MAC CE. The time/frequency location(s) and/or SSB(s) transmitted on demand for each SCell with a field Cj set to 1 and for which on demand SSB transmission is configured (or activated/status is activated in RRCReconfiguration or for which RRC indicates that activation is via the MAC CE) can be included sequentially in the MAC CE in increasing order of j. If the ‘A’ field is set to 0, UE 1002 may determine/assume/consider that an on demand SSB is not transmitted (or deactivated) by gNB 1004 for the SCell(s) for which a field Cj is set to 1 and for which on demand SSB transmission is configured (or activated/status is activated in RRCReconfiguration or for which RRC indicates that activation is via the MAC CE). UE 1002 may stop monitoring/measuring the on demand SSB transmission for the SCell(s) for which a field Cj is set to 1 and for which on demand SSB transmission is configured, in the time/frequency locations configured by the network (e.g., in an RRCReconfiguration message).

Alternately, in some embodiments, the MAC subheader may include an LCID/eLCID. The MAC subheader may also include a length field. An LCID/eLCID to indicate that the MAC CE in the MAC subPDU payload is an (Enhanced) SCell Activation/Deactivation MAC CE to activate the SCell and trigger on demand SSB transmission can be pre-defined. A MAC CE format to trigger on demand SSB transmission for SCell operation is shown in FIGS. 12A and 12B. The LCID/eLCID may be different for the formats shown in FIGS. 12A and 12B.

In some embodiments, for MAC CE format 1200, if there is an SCell configured for the MAC entity with a SCellIndex j, a field Cj may indicate the activation/deactivation status of the SCell with the SCellIndex j. A field Cj set to 1 may indicate that the SCell identified by SCellIndex j is activated. A field Cj set to 0 may indicate that the SCell identified by SCellIndex j is not activated (or deactivated). The ‘A’ field set to 1 may indicate that on demand SSB transmission for SCell(s) for which on demand SSB transmission is configured is activated/triggered/transmitted. The ‘A’ field set to 0 may indicate that on demand SSB transmission for SCell(s) for which on demand SSB transmission is configured is deactivated/not transmitted.

Upon receiving the TB at step 1050, UE 1002 may identify that the TB includes a MAC CE to trigger on demand SSB transmission based on the LCID/eLCID field in the MAC subheader. UE 1002 then may identify the serving cell(s)/SCell(s) for which the MAC CE applies. If a field Cj is set to 1, UE 1002 may determine that the field Cj is an activation command for the SCell identified by SCellIndex j. If a field Cj is set to 0, UE 1002 may determine that the field Cj is a deactivation command for the SCell identified by SCellIndex j. If the ‘A’ field is set to 1, UE 1002 may determine/assume/consider that on an demand SSB is transmitted (activated/triggered) by a gNB for the SCell(s) for which on demand SSB transmission is configured. UE 1002 may monitor/measure the on demand SSB transmission for the SCell(s) for which on demand SSB transmission is configured, in the time/frequency locations configured by the network (e.g., in an RRCReconfiguration message). In some embodiments, the time/frequency location(s) and/or SSB(s) transmitted on demand can be included in the MAC CE. The time/frequency location(s) and/or SSB(s) transmitted on demand for each SCell for which on demand SSB transmission is configured can be included sequentially in the MAC CE in increasing order of SCellIndex j. If the ‘A’ field is set to 0, UE 1002 may determine/assume/consider that an on demand SSB transmission is not transmitted (or deactivated) by a gNB for the SCell(s) for which on demand SSB transmission is configured. UE 1002 may stop monitoring/measuring the on demand SSB transmission for the SCell(s) for which on demand SSB transmission is configured, in the time/frequency locations configured by the network (e.g., in an RRCReconfiguration message). In some embodiments, the time/frequency location(s) and/or SSB(s) transmitted on demand can be included in the MAC CE.

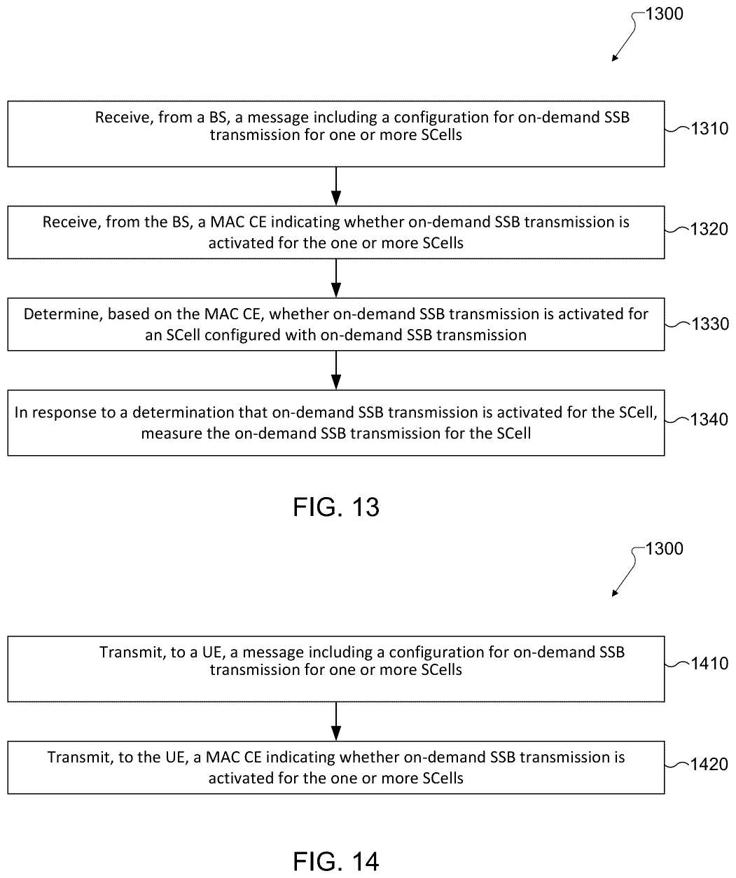

FIG. 13 illustrates an example method 1300 for configuring and activating on demand SSB transmission in SCells according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for configuring and activating on demand SSB transmission in SCells could be used without departing from the scope of this disclosure.

In the example of FIG. 13, method 1300 begins at step 1310, at step 1310, a UE (such as UE 502 or UE 1002) receives, from a BS (such as gNB 504 or gNB 1004), a message including a configuration for on-demand SSB transmission for one or more SCells. In some embodiments, the message including the configuration for on-demand SSB transmission for the one or more SCells is a radio resource control (RRC) message. In some embodiments, the RRC message indicates whether on-demand SSB transmission is activated for an SCell configured with on demand SSB transmission.

At step 1320, the UE receives, from the BS, a MAC CE indicating whether on-demand SSB transmission is activated for the one or more SCells. In some embodiments, a downlink transport block including the MAC CE may be scheduled by a PDCCH addressed to one of a RNTI configured for on-demand SSB transmission by the BS or a C-RNTI of the UE. In some embodiments, the MAC CE may include information indicating an on demand SSB configuration for the one or more SCells for which on-demand SSB transmission is activated.

At step 1330, the UE determines, based on the MAC CE, whether on-demand SSB transmission is activated for an SCell configured with on-demand SSB transmission.

At step 1340, in response to a determination that on-demand SSB transmission is activated for the SCell, the UE measures the on-demand SSB transmission for the SCell.

In some embodiments, the MAC CE may include a bitmap indicating whether on-demand SSB transmission is activated for the one or more SCells, and the UE may determine a size of the bitmap based on a highest serving cell index amongst serving cell indexes of the one or more SCells configured for on-demand SSB transmission. When the highest serving cell index amongst the serving cell indexes of the one or more SCells configured with on demand SSB transmission is less than eight, the MAC CE may include a bitmap of size eight. When the highest serving cell index amongst the serving cell indexes of the one or more SCells configured with on demand SSB transmission is not less than eight, the MAC CE may include a bitmap of size thirty-two.

In some embodiments, the UE may determine if a j^{th} bit of the bitmap corresponding to a serving cell index j of an SCell configured with on demand SSB transmission is set to one or zero. When the j^{th} bit of the bitmap corresponding to the serving cell index j of an SCell configured with on demand SSB transmission is set to one, on demand SSB transmission for the SCell may be activated. When the j^{th} bit of the bitmap corresponding to the serving cell index j of the SCell configured with on demand SSB transmission is set to zero, on demand SSB transmission for the SCell may be deactivated.

In some embodiments, the MAC CE may include a bitmap indicating whether on-demand SSB transmission is activated for the one or more SCells, and the UE may determine a size of the bitmap based on a total number of SCells configured for on-demand SSB transmission. When the total number of SCells configured for on-demand SSB transmission is greater than zero and less than eight, the MAC CE may include a bitmap of size eight. When the total number of SCells configured for on-demand SSB transmission is greater than seven and less than sixteen, the MAC CE may include a bitmap of size sixteen. When the total number of SCells configured for on-demand SSB transmission is greater than fifteen and less than twenty-four, the MAC CE may include a bitmap of size twenty-four. When the total number of SCells configured for on-demand SSB transmission is greater than twenty-three, the MAC CE may include a bitmap of size thirty-two.

In some embodiments, the UE may determine whether a j^{th} bit of the bitmap corresponding to a serving cell index j of an SCell configured with on demand SSB transmission is set to one or zero. When the j^{th} bit of the bitmap corresponding to the serving cell index j of an SCell configured with on demand SSB transmission is set to one, on demand SSB transmission for the SCell may be activated. When the j^{th} bit of the bitmap corresponding to the serving cell index j of the SCell configured with on demand SSB transmission is set to zero, on demand SSB transmission for the SCell may be deactivated.

In some embodiments, the MAC CE may include a bitmap indicating whether on-demand SSB transmission is activated for the one or more SCells, and the UE may determine a size of the bitmap based on a total number of SCells configured for on-demand SSB transmission. When the total number of SCells configured for on-demand SSB transmission is greater than zero and less than eight, the MAC CE may include a bitmap of size eight. When the total number of SCells configured for on-demand SSB transmission is greater than seven and less than sixteen, the MAC CE may include a bitmap of size sixteen. When the total number of SCells configured for on-demand SSB transmission is greater than fifteen and less than twenty-four, the MAC CE may include a bitmap of size twenty-four. When the total number of SCells configured for on-demand SSB transmission is greater than twenty-three, the MAC CE may include a bitmap of size thirty-two.

In some embodiments, the UE may sequentially index the SCells configured with on demand SSB transmission in increasing order of a respective serving cell index of each SCell configured with on demand SSB transmission.

In some embodiments, the UE may determine whether a j^{th} bit of the bitmap corresponding to a j^{th} SCell configured with on demand SSB transmission is set to one or zero. When the j^{th} bit of the bitmap corresponding to the j^{th} SCell configured with on demand SSB transmission is set to one, on demand SSB transmission for the j^{th} SCell may be activated. When the j^{th} bit of the bitmap corresponding to the j^{th} SCell configured with on demand SSB transmission is set to zero, on demand SSB transmission for the j^{th} SCell may be deactivated.

Although FIG. 13 illustrates one example method 1300 for configuring and activating on demand SSB transmission in SCells, various changes may be made to FIG. 13. For example, while shown as a series of steps, various steps in FIG. 13 could overlap, occur in parallel, occur in a different order, occur any number of times, be omitted, or replaced by other steps.

FIG. 14 illustrates another example method 1400 for configuring and activating on demand SSB transmission in SCells according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for configuring and activating on demand SSB transmission in SCells could be used without departing from the scope of this disclosure.

In the example of FIG. 14, method 1400 begins at step 1410, at step 1410, a BS (such as gNB 504 or gNB 1004) transmits, to a UE (such as UE 502 or UE 1002), a message including a configuration for on-demand SSB transmission for one or more SCells. In some embodiments, the message including the configuration for on-demand SSB transmission for the one or more SCells may be a radio resource control (RRC) message. In some embodiments, the RRC message may indicate whether on-demand SSB transmission is activated for an SCell configured with on demand SSB transmission.

At step 1420, the BS transmits, to the UE, a MAC CE indicating whether on-demand SSB transmission is activated for the one or more SCells. In some embodiments, the MAC CE may include information indicating an on demand SSB configuration for the one or more SCells for which on-demand SSB transmission is activated.

In some embodiments, a downlink transport block including the MAC CE is scheduled by a physical downlink control channel addressed to one of a radio network temporary identifier (RNTI) configured for on-demand SSB transmission by the BS or a cell RNTI (C-RNTI) of the UE.

In some embodiments, the MAC CE may include a bitmap indicating whether on-demand SSB transmission is activated for the one or more SCells, and the BS may generate the bitmap with a size based on a highest serving cell index amongst serving cell indexes of the one or more SCells configured for on-demand SSB transmission. When the highest serving cell index amongst the serving cell indexes of the one or more SCells configured with on demand SSB transmission is less than eight, the MAC CE may include a bitmap of size eight. When the highest serving cell index amongst the serving cell indexes of the one or more SCells configured with on demand SSB transmission is not less than eight, the MAC CE may include a bitmap of size thirty-two.

In some embodiments, the BS may determine whether on demand SSB transmission is activated for an SCell configured with on demand SSB transmission with a serving cell index j, set a j^{th} bit of the bitmap corresponding to the serving cell index j to one when on demand SSB transmission is activated for the SCell configured with on demand SSB, and set the j^{th} bit of the bitmap corresponding to the serving cell index j to zero when on demand SSB transmission is not activated for the SCell configured with on demand SSB.

In some embodiments, the MAC CE includes a bitmap indicating whether on-demand SSB transmission is activated for the one or more SCells, and the BS may generate the bitmap with a size based on a total number of SCells configured for on-demand SSB transmission. When the total number of SCells configured for on-demand SSB transmission is greater than zero and less than eight, the MAC CE may include a bitmap of size eight. When the total number of SCells configured for on-demand SSB transmission is greater than seven and less than sixteen, the MAC CE may include a bitmap of size sixteen. When the total number of SCells configured for on-demand SSB transmission is greater than fifteen and less than twenty-four, the MAC CE may include a bitmap of size twenty-four. When the total number of SCells configured for on-demand SSB transmission is greater than twenty-three, the MAC CE may include a bitmap of size thirty-two.

In some embodiments, the BS may sequentially index the SCells configured with on demand SSB transmission in increasing order of a respective serving cell index of each SCell configured with on demand SSB transmission.

In some embodiments, the BS may determine whether on demand SSB transmission is activated for a j^{th} SCell configured with on demand SSB transmission, set a j^{th} bit of the bitmap corresponding to the one when on demand SSB transmission is activated for the j^{th} SCell configured with on demand SSB, and set the j^{th} bit of the bitmap to zero when on demand SSB transmission is not activated for the j^{th} SCell configured with on demand SSB.

Although FIG. 14 illustrates one example method 1400 for configuring and activating on demand SSB transmission in SCells, various changes may be made to FIG. 14. For example, while shown as a series of steps, various steps in FIG. 14 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

1. A user equipment (UE) comprising:
a transceiver configured to:
receive, from a base station (BS), a message including a configuration for on-demand synchronization signal block (SSB) transmission for one or more secondary cells (SCells); and
receive, from the BS, a medium access control (MAC) control element (CE) indicating whether on-demand SSB transmission is activated for the one or more SCells; and
a processor operably coupled to the transceiver, the processor configured to:
determine, based on the MAC CE, whether on-demand SSB transmission is activated for an SCell configured with on-demand SSB transmission; and
in response to a determination that on-demand SSB transmission is activated for the SCell, measure the on-demand SSB transmission for the SCell.

2. The UE of claim 1, wherein a downlink transport block including the MAC CE is scheduled by a physical downlink control channel (PDCCH) addressed to one of a radio network temporary identifier (RNTI) configured for on-demand SSB transmission by the BS or a cell RNTI (C-RNTI) of the UE.

3. The UE of claim 1, wherein:
the MAC CE includes a bitmap indicating whether on-demand SSB transmission is activated for the one or more SCells;
the processor is further configured to determine a size of the bitmap based on a highest serving cell index amongst serving cell indexes of the one or more SCells configured for on-demand SSB transmission;
when the highest serving cell index amongst the serving cell indexes of the one or more SCells configured with on demand SSB transmission is less than eight, the MAC CE includes a bitmap of size eight; and
when the highest serving cell index amongst the serving cell indexes of the one or more SCells configured with on demand SSB transmission is not less than eight, the MAC CE includes a bitmap of size thirty-two.

4. The UE of claim 3, wherein:
the processor is further configured to determine whether a j^{th} bit of the bitmap corresponding to a serving cell index j of an SCell configured with on demand SSB transmission is set to one or zero;
when the j^{th} bit of the bitmap corresponding to the serving cell index j of an SCell configured with on demand SSB transmission is set to one, on demand SSB transmission for the SCell is activated; and
when the j^{th} bit of the bitmap corresponding to the serving cell index j of the SCell configured with on demand SSB transmission is set to zero, on demand SSB transmission for the SCell is deactivated.

5. The UE of claim 1, wherein:
the MAC CE includes a bitmap indicating whether on-demand SSB transmission is activated for the one or more SCells;
the processor is further configured to determine a size of the bitmap based on a total number of SCells configured for on-demand SSB transmission;
when the total number of SCells configured for on-demand SSB transmission is greater than zero and less than eight, the MAC CE includes a bitmap of size eight;
when the total number of SCells configured for on-demand SSB transmission is greater than seven and less than sixteen, the MAC CE includes a bitmap of size sixteen;
when the total number of SCells configured for on-demand SSB transmission is greater than fifteen and less than twenty-four, the MAC CE includes a bitmap of size twenty-four; and
when the total number of SCells configured for on-demand SSB transmission is greater than twenty-three, the MAC CE includes a bitmap of size thirty-two.

6. The UE of claim 5, wherein the processor is further configured to sequentially index the SCells configured with on demand SSB transmission in increasing order of a respective serving cell index of each SCell configured with on demand SSB transmission.

7. The UE of claim 6, wherein:
the processor is further configured to determine whether a j^{th} bit of the bitmap corresponding to a j^{th} SCell configured with on demand SSB transmission is set to one or zero;
when the j^{th} bit of the bitmap corresponding to the j^{th} SCell configured with on demand SSB transmission is set to one, on demand SSB transmission for the j^{th} SCell is activated; and
when the j^{th} bit of the bitmap corresponding to the j^{th} SCell configured with on demand SSB transmission is set to zero, on demand SSB transmission for the j^{th} SCell is deactivated.

8. The UE of claim 1, wherein the MAC CE includes information indicating an on demand SSB configuration for the one or more SCells for which on-demand SSB transmission is activated.

9. The UE of claim 1, wherein the message including the configuration for on-demand SSB transmission for the one or more SCells is a radio resource control (RRC) message.

10. The UE of claim 9, wherein the RRC message indicates whether on-demand SSB transmission is activated for an SCell configured with on demand SSB transmission.

11. A base station (BS) comprising:
a processor; and
a transceiver operatively coupled to the processor, the transceiver configured to:
transmit, to a user equipment (UE), a message including a configuration for on-demand synchronization signal block (SSB) transmission for one or more secondary cells (SCells); and
transmit, to the UE, a medium access control (MAC) control element (CE) indicating whether on-demand SSB transmission is activated for the one or more SCells.

12. The BS of claim 11, wherein a downlink transport block including the MAC CE is scheduled by a physical downlink control channel addressed to one of a radio network temporary identifier (RNTI) configured for on-demand SSB transmission by the BS or a cell RNTI (C-RNTI) of the UE.

13. The BS of claim 11, wherein:
the MAC CE includes a bitmap indicating whether on-demand SSB transmission is activated for the one or more SCells;
the processor is configured to generate the bitmap with a size based on a highest serving cell index amongst serving cell indexes of the one or more SCells configured for on-demand SSB transmission;
when the highest serving cell index amongst the serving cell indexes of the one or more SCells configured with on demand SSB transmission is less than eight, the MAC CE includes a bitmap of size eight; and
when the highest serving cell index amongst the serving cell indexes of the one or more SCells configured with on demand SSB transmission is not less than eight, the MAC CE includes a bitmap of size thirty-two.

14. The BS of claim 13, wherein the processor is further configured to:
determine whether on demand SSB transmission is activated for an SCell configured with on demand SSB transmission with a serving cell index j;
set a j^{th} bit of the bitmap corresponding to the serving cell index j to one when on demand SSB transmission is activated for the SCell configured with on demand SSB; and
set the j^{th} bit of the bitmap corresponding to the serving cell index j to zero when on demand SSB transmission is not activated for the SCell configured with on demand SSB.

15. The BS of claim 13, wherein:
the MAC CE includes a bitmap indicating whether on-demand SSB transmission is activated for the one or more SCells;
the processor is further configured generate the bitmap with a size based on a total number of SCells configured for on-demand SSB transmission;
when the total number of SCells configured for on-demand SSB transmission is greater than zero and less than eight, the MAC CE includes a bitmap of size eight;
when the total number of SCells configured for on-demand SSB transmission is greater than seven and less than sixteen, the MAC CE includes a bitmap of size sixteen;
when the total number of SCells configured for on-demand SSB transmission is greater than fifteen and less than twenty-four, the MAC CE includes a bitmap of size twenty-four; and
when the total number of SCells configured for on-demand SSB transmission is greater than twenty-three, the MAC CE includes a bitmap of size thirty-two.

16. The BS of claim 15, wherein the processor is further configured to sequentially index the SCells configured with on demand SSB transmission in increasing order of a respective serving cell index of each SCell configured with on demand SSB transmission.

17. The BS of claim 16, wherein the processor is further configured to:
determine whether on demand SSB transmission is activated for a j^{th} SCell configured with on demand SSB transmission;
set a j^{th} bit of the bitmap corresponding to the one when on demand SSB transmission is activated for the j^{th} SCell configured with on demand SSB; and
set the j^{th} bit of the bitmap to zero when on demand SSB transmission is not activated for the j^{th} SCell configured with on demand SSB.

18. The BS of claim 11, wherein the MAC CE includes information indicating an on demand SSB configuration for the one or more SCells for which on-demand SSB transmission is activated.

19. The BS of claim 11, wherein the message including the configuration for on-demand SSB transmission for the one or more SCells is a radio resource control (RRC) message.

20. The BS of claim 19, wherein the RRC message indicates whether on-demand SSB transmission is activated for an SCell configured with on demand SSB transmission.
